(19) United States
(12) Patent Application Publication
(10) Pub. No.: US 2004/0128203 A1
(43) Pub. Date: Jul. 1, 2004

(54) Scheme for creating and delivering a new customized computer system with the "personality" of a user's other computer system pre-installed

(76) Inventors: Christa St. Pierre, Fort Lauderdale, FL (US); David L. Henrickson, Miami, FL (US)

Correspondence Address: Gregory P. Gadson, Esq., 19375 Amber Way, Noblesville, IN, 46060, US

(21) Appl. No.: 10/329,868

(22) Filed: Dec. 26, 2002

(51) Int. Cl. G06F 17/60

(52) U.S. Cl. 705/26

(57) ABSTRACT

A novel scheme for creating and delivering a new customized computer system (e.g., a PC), delivers the new system with the “personality” of another of the prospective end-user's computer systems already installed prior to delivery. The “personality” includes such things as the application software, files, and personal settings of the old system chosen by the end-user to be migrated to the new system. A migration survey tool (MST) surveys the contents of a migration source computer (MSC) and lists the contents (including personal settings) to be migrated to a migration target computer (MTC) which has been (or will be) newly purchased, but not yet delivered. In an interactive fashion, the end-user determines which of the listed contents will make up the personality and be migrated to the new system, and causes the personality to be placed in a migration file. In one embodiment, the migration file is uploaded via the Internet to a website maintained by the OEM responsible for delivering the new computer system, wherefore the OEM installs the end-user's personality on the new MTC prior to delivering it to the end-user. The MST can also be delivered on a physical storage medium (e.g., a CD-ROM disc can be delivered to the OEM). The MST can be installed locally in the MSC, downloaded via the Internet, to or transferred from another source such as a server on a LAN.

### BACKGROUND OF THE INVENTION

1. Field of the Invention

The present invention relates to methods and systems for receiving orders and delivering customized computers. The present invention also relates to computer system migration.

2. Background

Computer migration may be broadly defined as the process of transferring some or all of a “source” computer's information, non-device assets or intellectual property, to a “target” computer. The computer migration process is often carried out via a special computer migration tool kit in the form of software loaded on the source computer, the target computer, or both. The two computers involved in the migration process can be linked in a variety of ways, including, inter alia, direct cables/wires, direct telephone links, Local Area Networks (LANs), and Wide Area Networks (WANs). Alternatively, another approach is to use an intermediate storage device or system (e.g., rewritable or write-once CDs, ZIP® storage devices, network storage, etc.) to which to transfer aspects of the source computer. The aspects to be migrated are then transferred from the intermediate device to the target computer.

With rapid advancements in the computing power and memory capacity of widely available desktop computers, as well as others, the practical life cycle of computer systems continues to decrease. While users continue to switch to newer computer systems, there is very often a need and desire to transfer important aspects of the old computer system to the new computer system. One prior art approach is represented by U.S. patent application Ser. No. 09/378,999 filed Aug. 23, 1999 and titled “Application And Method For Transferring Information Between Platforms,” which patent application is assigned to the assignee of this letters patent. The abstract of that application describes the approach as follows:

A method and apparatus for relocating programs, settings, menus, files and documents from a source computer to a target computer. The method and apparatus function properly regardless of whether the source and target computers have the same hardware or operating system. The method includes scanning the source and target machines for all applications programs, settings, menus, files, and documents in order to create a relocation strategy. The relocation strategy is created in view of pre-programmed selection rules or selection rules created by the user. The strategy is then implemented by copying, replacing or merging data from the source machine to the target machine.

Another approach to computer migration is described in U.S. patent application Ser. No. 10/094,251 filed Mar. 8, 2002 and titled “Non-Script Based Intelligent Migration Tool Capable Of Migrating Software Selected By A User, Including Software For Which Said Migration Tool Has Had No Previous Knowledge Or Encounters,” which patent application is also assigned to the assignee of this letters patent. The abstract of that application describes its approach as follows:

A novel computer migration tool allows a user to selectively migrate assets of choice from a source computer to a target computer. The migration tool is non-script based, and intelligently ascertains “on the fly,” which assets on the source computer are part of each program, whether or not the migration tool has previous information about the programs or has ever encountered said programs. The novel techniques of determining how all of the files of a source computer are to be grouped (i.e., to which programs, files are associated) include examining installation log files created by “installation technology,” where they exist. Where installation log files do not exist, the migration tool uses a rules-based approach to group files (into programs) according to common folders, common creation dates, common modification dates, and, examining file allocation tables, group files that are proximate. After assets are grouped into Application Groups, a Confidence Level test is performed to determine a degree of confidence that all of the items belonging to the Application Group have in fact been associated with the group. The user is presented with all of the Application Groups and their associated confidence level via an interactive display. The user then chooses programs, files and other assets to migrate to the target computer.

When new (whether actually new or previously unused by the particular end-user) computer systems are purchased, all prior art approaches to migration begin when the new computer arrives to its new physical location or is in the actual possession of the end-user. For example, when a new desktop computer is purchased and unpacked from the shipping boxes, the new computer (target computer) can be connected via cable or LAN to the old computer (source computer) and a migration tool installed on one or both of the computers facilitates the migration process. Alternative to a direction connection between the source and target computers, the migration tool can store the items and settings to be migrated from the source computer onto a CD-ROM, for example, and then the target computer installs the migrated components from the CD-ROM.

What is completely unaddressed by the prior art is the need to have new computer systems delivered that are already personalized with application software, data files, menus, and settings and preferences, etc., for the particular purchaser or end-user. This would allow the end-user to be both productive and more comfortable with the new computer with the initial power-up, rather than having to take the time to migrate the desired source computer contents to the new target computer after it has arrived. In this manner, the actual migration of components could be seamless to the end-user, and the Original Equipment Manufacturer (OEM) responsible for assembling the new computer can use its natural process efficiencies and economies of scale to better effect the migration.

### SUMMARY OF THE INVENTION

In view of the aforementioned problems and deficiencies of the prior art, the present invention provides a method for creating and delivering a customized computer system. The method at least includes the steps of activating a migration survey tool (MST) to survey the contents of a migration source computer (MSC), via the MST, allowing a prospective end-user having dominion over the MSC to create a migration file with the end-user's “personality,” and transferring the migration file to an instrumentality over which an Original Equipment Manufacturer (OEM) has dominion. The method further at least includes the steps of receiving an order for a computer system serving as a migration target computer (MTC) to be delivered from the OEM or its agent, installing the end-user's “personality” on the MTC, and following the latter step, delivering the MTC.

The present invention also provides a system for creating and delivering a customized computer system. The system at least includes an MST, an OEM, and a MST adapted to survey the contents of the MSC. The system further at least includes at least one migration file created by a prospective end-user having dominion over the MSC, the migration file having the enduser's “personality,” a migration file transferor adapted to transfer the migration file to an instrumentality over which the OEM has dominion, and an ordering mechanism adapted to allow the end-user or the end-user's agent to order a computer system serving as an MTC from the OEM or an agent of the OEM. The OEM is adapted to install the end-user's “personality” on the MTC, and following the installation of the end-user's “personality,” deliver the MTC.

### BRIEF DESCRIPTION OF THE DRAWING FIGURES

Features and advantages of the present invention will become apparent to those skilled in the art from the description below, with reference to the following drawing figures, in which:

FIG. 1 is a general schematic block diagram of a system capable of implementing the present-inventive custom computer creation and delivery method;

FIG. 2 is a general schematic block diagram of an alternate system capable of implementing the present-inventive custom computer creation and delivery method;

FIG. 3 is a flowchart detailing the steps of the preferred embodiment of the present-inventive custom computer creation and delivery method;

FIG. 4 is a flowchart detailing the steps of an alternate embodiment of the present-inventive custom computer creation and delivery method; and

FIG. 5 is a flowchart detailing the steps of yet another alternate embodiment of the present-inventive custom computer creation and delivery method.

### DESCRIPTION OF THE PREFERRED EMBODIMENTS

The term “personality” is used broadly in the specification and claims of this Letters Patent to include not only algorithms that make up software, but data associated with software, data files, menus, documents, and any user settings or preferences that a computer system user may use, whether related to the general operation of the computer (such as sounds, volume, display characteristics, start-up characteristics, default settings, etc.), or related to particular applications.

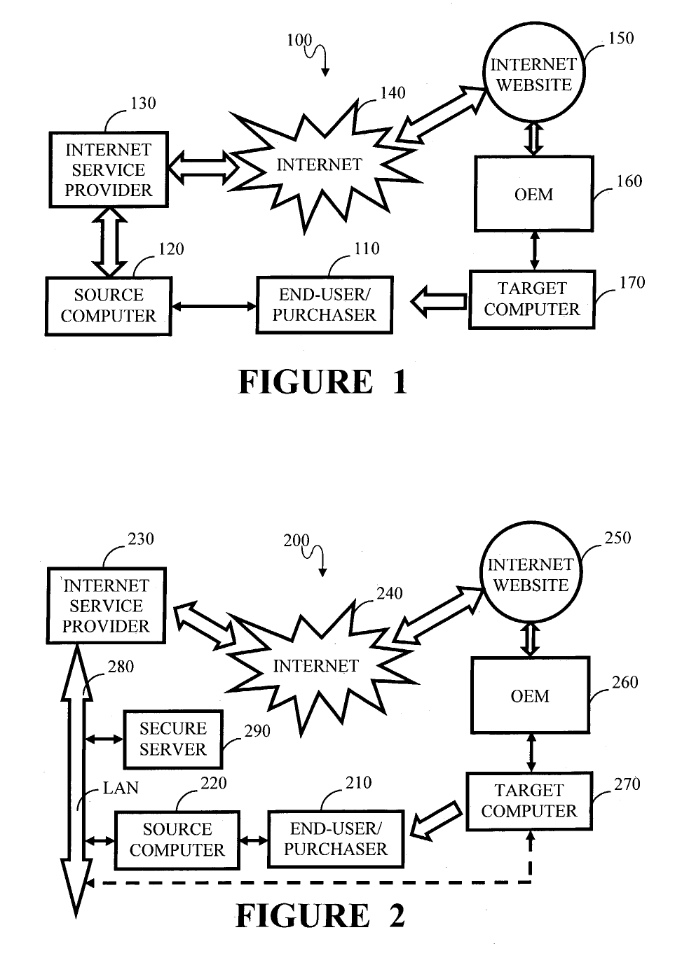

A basic system 100 for carrying out the present-inventive new computer creation and customization method is shown in FIG. 1. A purchaser who may also be the end-user 110 can start the new computer ordering process from an existing computer 120, which might serve as a migration source computer. In a manner known in the art, the end-user connects to his or her Internet Service Provider (ISP) 130 and then to a WAN such as the Internet 140. An OEM 160 who is a vendor of new computer systems maintains an Internet website 150.

To order a new computer, the purchaser 110 connects to the website 150 and initiates a purchase operation. The website (via servers, etc.) queries the purchaser about whether he or she would like to migrate contents from the old computer system to the new one (target computer 170). If migration is desired, the website downloads a migration toolkit to the source computer 120. Upon activation, the migration toolkit surveys the contents of the source computer 120, and lists them for the purchaser. The purchaser can choose to migrate all of the contents of the source computer, or only those of interest. The migration toolkit also advises the purchaser with regard to which components may cause conflicts and instability if installed on the target computer.

All of the components chosen to be migrated make up the end-user's “personality,” and are stored in a migration file and uploaded to the website 150. When the purchase transaction is complete (including payment or billing as is appropriate), the website 150 sends a detailed purchase order to the OEM, along with the migration file. From the migration file, the OEM loads the personality onto the hard drive of the new target computer 170. Afterwards, the OEM ships or delivers the new computer system 170 to the purchaser 110.

In the alternate embodiment 200 of FIG. 2, all of the components function similar to those in FIG. 1 with corresponding second and third digits. For example, the Internet Service Provider 230 corresponds to the Internet Service Provider 130 in FIG. 1. In the embodiment of FIG. 2, rather than uploading the migration file to the OEM 260, the migration file is transferred over a LAN 280 to secure server 290 for storage. When the new computer 270 is received from the OEM, the personality is loaded from the secure server 290 to the new target computer 270.

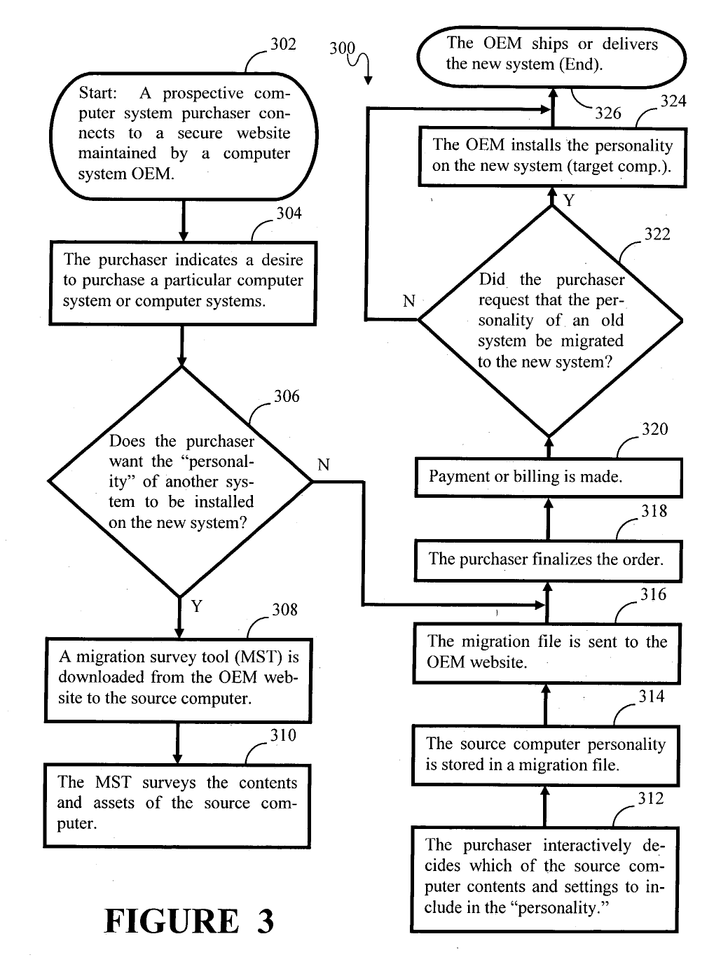

The flowchart in FIG. 3 details the preferred algorithm 300 of the novel customized computer creation and delivery method. To start the process in Step 302, a prospective computer system purchaser connects to a secure website maintained by a computer system OEM. Then, the purchaser indicates a desire to purchase a particular computer system or computer systems in Step 304. If the purchaser wants the personality from another computer to be installed on the new computer, a migration survey tool (MST) is downloaded from the OEM website to the source computer (Steps 306 and 308). If not, the algorithm jumps to Step 318, where the purchaser finalizes the order, and then makes payment or billing arrangements (Step 320).

Following Step 308, the MST surveys the contents and assets of the source computer (Step 310). The purchaser then interactively decides which of the source computer contents and settings to include in the personality in Step 312. The personality is stored in a migration file in Step 314, and then sent to the OEM in Step 316.

If the purchaser has requested that a personality from another computer be installed on the new computer, the OEM installs the personality prior to delivering the new computer to the purchaser (Steps 322, 324 and 326). If there is no request to install a personality, a new, non-custom (i.e., without an installed personality) computer is delivered to the purchaser (Steps 322 and 324).

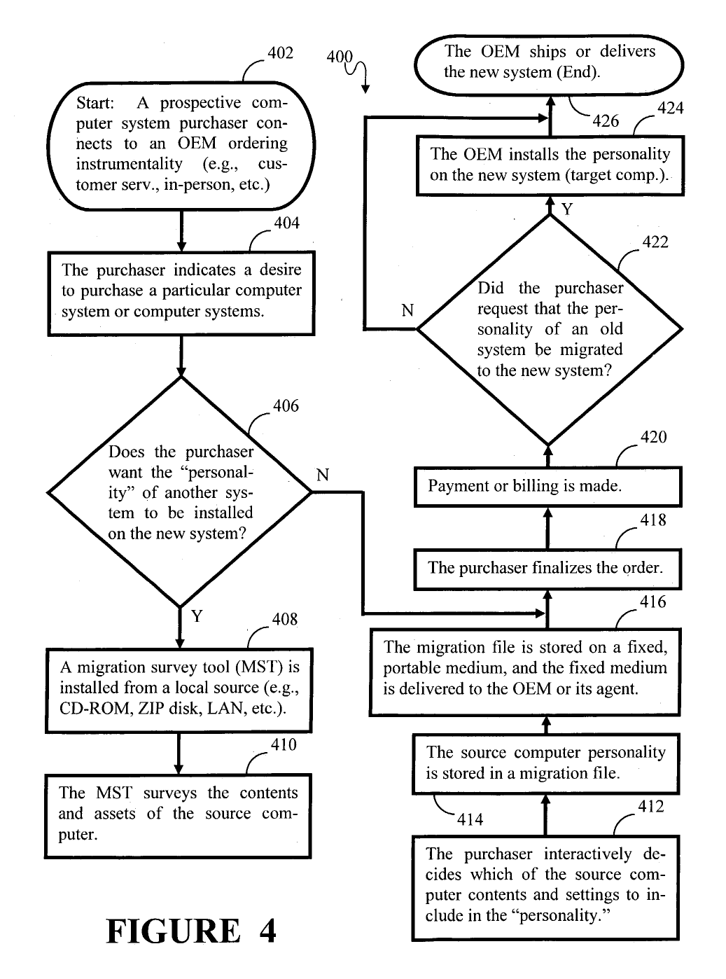

In the alternate approach represented by the algorithm 400 in FIG. 4, the steps are identical to those in the algorithm 300, except that the migration survey tool is not downloaded from OEM's website, but loaded onto the source computer from a local source (Step 408). The personality is stored on a fixed, portable medium such as a CD-ROM (Step 416), rather than being sent to the OEM electronically. The other steps in the algorithm 400 are identical to those in the algorithm 300. Given the teachings above, those skilled in the art will appreciate that the MST can be loaded from a local source or a remote source, and that the migration file can be stored and delivered in a variety of ways, including, inter alia, direct uploading through the Internet, via e-mail, or by way of creating and delivering a physical, transportable storage medium.

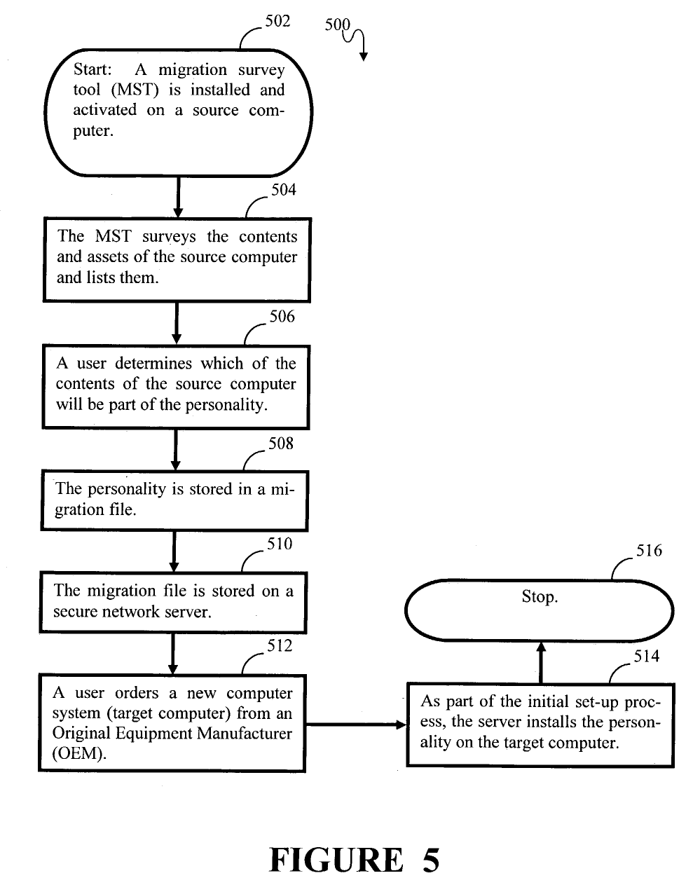

FIG. 5 illustrates yet another variation of the present invention where the migration file is stored locally on a secure network server. The steps of this algorithm 500 are similar to those of the algorithms 300 and 400 in FIGS. 3 and 4, respectively. To start the process in Step 502, the MST is installed and activated on the source computer. The MST surveys the contents and assets of the source computer and makes a list in Step 504. The user determines in an interactive fashion, which items from the list will comprise the “personality” (Step 506). The personality is stored in a migration file, and the migration file is stored on a secure network server (Steps 508 and 510).

In Step 512, the purchaser/user purchases a new target computer from an OEM. When the new computer is received, the personality is installed from the secure server as part of the initial set-up process (Step 514). The algorithm stops at Step 516.

The purchaser using algorithm 500 might be a corporate entity with multiple employee-users networked on a LAN. The personality might be that of an end-user who is actually replacing his or her computer, or, for example, a standard personality that the corporate entity places on all purchased computer systems.

Variations and modifications of the present invention are possible, given the above description. However, all variations and modifications which are obvious to those skilled in the art to which the present invention pertains are considered to be within the scope of the protection granted by this Letters Patent.

It should be understood that the novel teachings of the present invention can be utilized regardless of the size or complexity of the source and target computers (i.e., PC-to-PC migrations, mainframe-to-mainframe migrations, combinations or gradations of these, as well as migrations where one or more special purpose digital device is involved are all applicable).

What is claimed is:

1. A method for preparing and delivering a customized computer system comprising the steps of:
a) activating a migration survey tool (MST) to survey the contents of a migration source computer (MSC);
b) via said MST, allowing a prospective end-user having dominion over said MSC to create a migration file with the end-user's personality;
c) transferring said migration file to an instrumentality over which an Original Equipment Manufacturer (OEM) has dominion;
d) receiving an order for a computer system serving as a migration target computer (MTC) to be delivered from said OEM or its agent;
e) installing the end-user's personality on said MTC; and
f) following step d), delivering the MTC.

2. The method of claim 1, wherein said personality comprises application programs on the MSC selected by said end-user.

3. The method of claim 1, wherein said personality comprises data files on the MSC selected by said end-user.

4. The method of claim 1, wherein said personality comprises user settings on the MSC selected by said end-user.

5. The method of claim 1, further comprising the step of locally installing said MST.

6. The method of claim 1, further comprising the step of installing said MST as a download from wide area networked (WANed) source.

7. The method of claim 1, further comprising the step of installing said MST from a local area networked (LANed) source.

8. The method of claim 1, wherein step c) is carried out via a WAN.

9. The method of claim 1, wherein the act of transferring in step c) comprises:
storing said migration file on a fixed medium; and
delivering said fixed medium to said instrumentality.

10. The method of claim 1, wherein all of the steps except step f) are carried out with the aid of the Internet.

11. The method of claim 1, further comprising the step of:
installing said wherein step e) is carried out remotely from said OEM or an OEM agent, by an instrumentality of an entity carrying out step d), and wherein said entity also carries out step f).

12. A method for preparing and delivering a customized computer system comprising the steps of:
a) activating a migration survey tool (MST) to survey the contents of a migration source computer (MSC);
b) via said MST, allowing a prospective end-user having dominion over said MSC to create a migration file with the end-user's personality;
c) transferring said migration file to an instrumentality over which a purchasing entity has dominion;
d) via an Original Equipment Manufacturer (OEM) or its agent, receiving an order for a computer system serving as a migration target computer (MTC) to be delivered from said OEM or its agent;
e) delivering said MTC to said purchasing entity; and
f) via an instrumentality of said purchasing entity, installing the enduser's personality on said MTC.

13. A system for preparing and delivering a customized computer system comprising:
a migration source computer (MST);
an Original Equipment Manufacturer (OEM);
a migration survey tool (MST) adapted to survey the contents of said MSC;
at least one migration file created by a prospective end-user having dominion over said MSC, said migration file having the end-user's personality;
a migration file transferor adapted to transfer said migration file to an instrumentality over which said OEM has dominion; and
an ordering mechanism adapted to allow the end-user to order a computer system serving as a migration target computer (MTC) from said OEM or an agent of said OEM;
wherein said OEM is adapted to install the end-user's personality on said MTC, and following the installation of the end-user's personality, deliver the MTC.

14. The system of claim 13, wherein said personality comprises application programs on the MSC selected by said end-user.

15. The system of claim 13, wherein said personality comprises data files on the MSC selected by said end-user.

16. The system of claim 13, wherein said personality comprises user settings on the MSC selected by said end-user.

17. The system of claim 13, wherein said MST is adapted to be locally installed on said MST.

18. The system of claim 13, wherein said MST is adapted to be installed as a download from wide area networked (WANed) source.

19. The system of claim 13, wherein said MST is adapted to be installed from a local area networked (LANed) source.

20. The system of claim 13, wherein said migration file transferor comprises a WAN.

21. The system of claim 13, wherein said migration file transferor comprises:
at least one fixed medium adapted to store said migration file; and
and a delivering mechanism adapted to deliver said fixed medium to said instrumentality.

22. The system of claim 13, wherein all of the elements of the system function with the aid of the Internet.

23. The system of claim 13, method of claim 1, further comprising the step of:
installing said wherein step e) is carried out remotely from said OEM or an OEM agent, by an instrumentality of an entity carrying out step d), and wherein said entity also carries out step f).
